(19) United States
(12) Patent Application Publication
(10) Pub. No.: US 2023/0075301 A1
(43) Pub. Date: Mar. 9, 2023

(54) Shot Peening Apparatus

(71) Applicant: SUNCALL CORPORATION, Kyoto (JP)

(72) Inventors: Yasunari Kudou, Kyoto (JP); Rensaku Itou, Kyoto (JP); Atsushi Kondou, Kyoto (JP); Masashi Tashiro, Kyoto (JP); Ryuuji Kishihara, Kyoto (JP)

(21) Appl. No.: 17/987,480

(22) Filed: Nov. 15, 2022

Related U.S. Application Data
(63) Continuation of application No. PCT/JP2021/018547, filed on May 17, 2021.

(30) Foreign Application Priority Data
Jun. 18, 2020 (JP) 2020-104977

(51) Int. Cl. B24C 3/08

(52) U.S. Cl. CPC B24C 3/083

(57) ABSTRACT

A shot peening apparatus capable of precisely controlling the amount of shots supplied projects, by a shot impeller, shots onto a workpiece, and has a bucket elevator which conveys the shots to a predetermined height, a motor which drives the bucket elevator, and a control device which controls the current value of the motor. The control device issues an alert when the current value of the motor becomes lower than a predetermined current value.

### FIELD OF THE INVENTION

The present invention relates to a shot peening apparatus configured to project shots onto a workpiece.

### BACKGROUND OF THE INVENTION

As a conventional shot peening apparatus, for example, a shot peening apparatus as described in Japanese Patent No. 6304957, after shots are conveyed upward by a bucket elevator, the shots are supplied toward a horizontal screw, flowed into a guide line from the horizontal screw, dropped downward along a guide line, guided to an impeller, and are thus projected toward workpieces by the impeller.

### SUMMARY OF THE INVENTION

According to the shot peening apparatus as described above a supply amount of shots is controlled by checking a current value of a motor that rotates blades (impeller) at high speed. That is, it is configured so that when a current value of the motor decreases, it is determined that the supply amount of shots is in short because rotational load of the blades (impeller) is in a state of low, then the shots are added.

However, in such a control method, there was a problem that the supply amount of shots may not be accurately controlled, because even in a state where supply amount of shots supplied to the blades (impeller) is in short, the blades (impeller) may take in surrounding atmosphere due to a high-speed rotation of the blades (impeller), thereby the rotational load of the blades (impeller) increases and the current value of the motor increases.

The present invention has been made in view of the above problems, and an object thereof is to provide a shot peening apparatus capable of accurately controlling the supply amount of shots.

The foregoing object of the present invention is achieved by the following means. It is noted that reference signs in an embodiment to be described later are added in parentheses, but the present invention is not limited thereto.

According to the first aspect of the present invention, a shot peening apparatus (1) for projecting shots (T) onto a workpiece W by a projection means (e.g., a shot impeller 5), which comprises:

an elevating conveyance means (e.g., a bucket elevator 2) for conveying the shots (T) to a predetermined height;

a motor (M) for driving the elevating conveyance means (e.g., the bucket elevator 2); and

a control means (e.g., a control device 3) for controlling a current value of the motor (M).

Further, according to the second aspect of the present invention, the shot peening apparatus according to the above first aspect is characterized in that, the control means (e.g., the control device 3) issues an alert when a current value of the motor (M) falls below a predetermined current value.

Further, according to the third aspect of the present invention, the shot peening apparatus according to the above first aspect is characterized in that, the control means (e.g., the control device 3) issues an alert when a current value of the motor (M) exceeds a predetermined current value.

Next, advantageous effects of the present invention will be described with reference signs in the drawings. It is noted that reference signs in an embodiment to be described later are added in parentheses, but the present invention is not limited thereto.

According to the first aspect of the present invention, the control means (e.g., the control device 3) controls the current value of the motor (M) that drives the elevating conveyance means (e.g., the bucket elevator 2) for conveying shots (T) to a predetermined height, this allows to control a supply amount of the shots accurately.

Further, according to the second aspect of the present invention, the control means (e.g., the control device 3) is configured to issue an alert when a current value of the motor (M) falls below a predetermined current value, this allows to notify the outside of the shortage of the supply amount of the shots (T) at an early stage. Moreover, the control means can notify the outside of the fact that the shots (T) having large particle size have been mixed.

Further, according to the third aspect of the present invention, the control means (e.g., the control device 3) is configured to issue an alert when a current value of the motor (M) exceeds a predetermined current value, this allows to notify the outside at an early stage that an abnormality has occurred in the dust collection capacity of the dust collector (not shown). Moreover, the control means can notify the outside at an early stage that the shots (T) have been excessively put into the shot peening apparatus (1). Furthermore, the control means can notify the outside at an early stage that the shots (T) having different volumetric density (shots T of different sizes) have been mixed, and it is also possible to notify the outside at an early stage that the shots (T) having small particle size have been mixed.

### BRIEF DESCRIPTION OF THE DRAWINGS

FIG. 1 is a schematic side view of a shot peening apparatus according to an embodiment of the present invention.

### DETAILED DESCIPTION OF A PREFERED EMBODIMENT

Hereinafter, an embodiment of a shot peening apparatus according to the present invention will be specifically described with reference to the drawings. It is noted that, in the following description, when vertical and horizontal directions are indicated, it shall mean vertical and horizontal directions when viewed from the front of the figure.

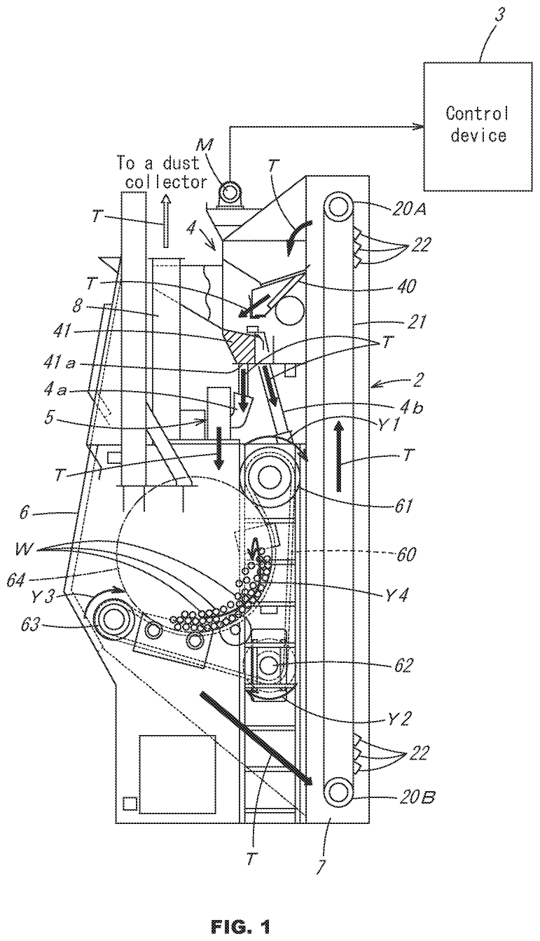

As shown in FIG. 1, the shot peening apparatus 1 performs shot peening treatment in which particles (shots T) are collided with the surfaces of the object W to be treated at high speed. Specifically, as shown in FIG. 1, the shot peening apparatus 1 is mainly composed of a bucket elevator 2 for supplying shots T, a control device 3 for controlling a current value of a motor M, a guide portion 4 for guiding the shots T to a shot impeller 5, the shot impeller 5 for projecting shots onto workpieces W and a shot chamber 6. The workpieces W may be, for example, coil springs. Hereinafter, each configuration will be described in detail.

As shown in FIG. 1, the bucket elevator 2 includes an upper pulley 20A arranged at an upper portion of the shot peening apparatus 1, a lower pulley 20B arranged at a lower portion of the shot peening apparatus 1, an endless belt 21 wound around the upper pulley 20A and the lower pulley 20B, and a large number of buckets 22 (only a part is shown in the drawing) attached to the endless belt 21. The upper pulley 20A is connected to a motor M shown in FIG. 1 so that it can be driven to rotate. Thus, the bucket elevator 2 is configured so as to scoop up the shots T with the buckets 22 and to convey the shots T in the buckets 22 toward the upper side of the guide portion 4 by the upper pulley 20A rotated by the motor M.

The control device 3 controls the current value of the motor M which rotates the upper pulley 20A. More specifically, the control device 3 detects a shortage of the supply amount of shots T by controlling the current value of the motor M for rotating the upper pulley 20A. That is, if the current value of the motor M falls below a certain current value (e.g., 2A), the load on the motor M for the upper pulley is low, and if the load on the motor M for the upper pulley 20A is low, the weight of the plurality of buckets 22 attached to the endless belt 21 is light, and if the weight of the plurality of buckets 22 is light, the amount of the shots T in the plurality of buckets 22 is small, so it follows that the control device 3 can detect a shortage of the supply amount of shots T. At this time, when the control device 3 detects the shortage of the supply amount of shots T, it will issue an alert to the outside. Thereby it enables the control device 3 to inform the outside of the shortage of the supply amount of shots T at an early stage.

As shown in FIG. 1, the guide portion 4 includes a guide plate 40 and a tank 41. The guide plate 40 is arranged in an obliquely downward direction, so that the shots T conveyed toward the upper side of the guide portion 4 by the bucket elevator 2 can be guided to the tank 41. The tank 41 is adapted to temporarily store the shots T guided by the guide plate 40. Furthermore, as shown in FIG. 1, a guide pipe 4a for guiding the shots T to the shot impeller 5 via a cut gate 41a is disposed directly below the tank 41. Accordingly, the shots T temporarily stored in the tank 41 passes through the guide pipe 4a and are guided to the shot impeller 5. Furthermore, the cut gate 41a adjusts the flow rate of the shots T to be supplied to the shot impeller 5 by opening and closing.

Whereas, when the shots T guided by the guide plate 40 are not stored in the tank 41 and overflow from the tank 41 (in case of overflow), they are discharged from an overflow pipe 4b disposed at the lower right side of the tank 41 as shown in FIG. 1. Furthermore, the shots T discharged from the overflow pipe 4b are discharged to a shot collecting unit 7 which will be described later.

The shot impeller 5 rotates blades at high speed using a motor (not shown), and projects the shots T onto the workpieces W by a centrifugal force of blades (impeller) rotating at high speed.

The shot chamber 6 is installed at a lower portion of the shot impeller 5, and the workpieces W are disposed inside. This workpieces W are disposed on an endless belt 60 arranged in the shot chamber 6. The endless belt 60 is extended between an elongated upper right pulley 61 positioned on the upper right side of the drawing shown in FIG. 1, an elongated lower right pulley 62 positioned on the lower right side of the drawing shown in FIG. 1, and an elongated left pulley 63 positioned on the left side of the drawing shown in FIG. 1. A motor (not shown) is connected to the upper right pulley 61. Thus, when the motor (not shown) drives, the upper right pulley 61 is rotationally driven clockwise (as indicated by the arrowed line Y1 in FIG. 1), and then the endless belt 60 is also moved in the direction of arrowed line Y1 in FIG. 1, whereby the lower right pulley 62 is rotationally driven clockwise (arrowed line Y2 in FIG. 1) and the left pulley 63 is rotationally driven clockwise (arrowed line Y3 in FIG. 1). Thereby as the upper right pulley 61, the lower right pulley 62 and the left pulley 63 are rotationally driven, the endless belt 60 moves clockwise between the upper right pulley 61, the lower right pulley 62 and the left pulley 63.

Thus, as described above, when the endless belt 60 is moved, the workpieces W disposed on the endless belt 60 are lifted up to the upper right pulley 61 side (up-pointing arrowed line Y4 in FIG. 1), and when lifted up to a certain height, they fall down like an avalanche (down-pointing arrowed line Y4 in FIG. 1), whereby the workpieces W are agitated, and thus the shots T projected from the shot impeller 5 are projected onto the entire surface of the workpieces W. Incidentally reference numeral 64 denotes side disks arranged on both left and right sides of the endless belt 60, so that the workpieces W do not drop from the left and right sides of the endless belt 60.

The shots T after being projected onto the workpieces W are collected in the shot collecting unit 7 shown in FIG. 1. The shot collecting unit 7 is connected to the shot chamber 6. Thereby, the shots T projected onto the workpieces W are collected in the shot collecting unit 7 from the shot chamber 6. Further, as shown in FIG. 1, the shot collecting unit 7 is disposed at a lower portion of the bucket elevator 2. Thus, the shots T collected in the shot collecting unit 7 are scooped up by the buckets 22. Accordingly, the shots T scooped up by the buckets 22 are again conveyed toward the upper side of the guide portion 4 by the bucket elevator 2. Thereby, a circulation system is formed in which the shots T circulate. As described above, the shots T discharged from the overflow pipe 4b are also collected in the shot collecting unit 7, then the shots T are also scooped up by the buckets 22 and circulated.

Thus, according to the present embodiment described above, the supply amount of shots can be precisely controlled by controlling the current value of the motor M capable of conveying the shots T in the buckets 22 toward the upper side of the guide portion 4. Whereas, conventionally a current value of a motor (not shown) for rotating blades of the shot impeller 5 at a high speed was controlled. However, in such configuration, when the shots T are not stored in the tank 41 or the amount of the shots T is extremely small, in some cases, the blades (impeller) took in the atmosphere in the tank 41 via the guide pipe 4a. In doing so, since the rotational load of the blades (impeller) increases, the current value of the motor increases, and therefore, conventionally there was a problem that the supply amount of shots T could not be accurately controlled.

Then, in the present embodiment, it is configured so that the current value of the motor M capable of conveying the shots T in the buckets 22 toward the upper side of the guide portion 4 is controlled instead of controlling the motor (not shown) of the blades (impeller) rotating at high speed. Thus, in this way, since there are no parts which rotates at high speed, the situation of taking in the atmosphere does not occur as in the past, and the current value of the motor M can be accurately controlled. Therefore, according to the present embodiment, the supply amount of shots can be accurately controlled.

It is also possible to automatically supply the shots T to the shot peening apparatus 1 when the current value decreases, by controlling the current value of the motor M which can convey the shots T in the buckets 22 toward the upper side of the guide portion 4.

The shape and the like shown in the present embodiment are merely examples, and various modifications and changes can be made within the scope of the gist of the present invention described in the claims. For example, the bucket elevator 2, the guide portion 4, the shot impeller 5, the shot chamber 6, and the shot collecting unit 7 described in the present embodiment are merely examples, and any shapes and configurations may be used as long as they have the same functions as those described above.

In addition, in the present embodiment, an example is shown in which the control device 3 controls the current value of the motor M capable of conveying the shots T in the buckets 22 toward the upper side of the guide portion 4. However, the present invention is not limited thereto, and it may be configured so that both of the current values of the motor M and of the motor (not shown) for rotating the blades of the shot impeller 5 at high speed are controlled. Thus, if both current values are controlled, when the shot peening apparatus 1 fails, it is possible to immediately identify whether the failure location is on the bucket elevator 2 side or on the shot impeller 5 side.

Further, in the present embodiment, an example is shown in which when the current value of the motor M is lower than a certain current value (e.g., 2A) an alert is issued by the control device 3, but the present invention is not limited thereto, and it may be configured so that an alert may also be issued to the outside by the control device 3 when the current value of the motor M exceeds a certain current value (e.g., 3A). In this way, it will be possible to inform the outside of the occurrence of an abnormality in the dust collecting capacity of the dust collector (not shown) at an early stage.

The reference numeral 8 shown in FIG. 1 depicts a part of the dust collecting duct 8, and the worn shots T are removed to a dust collector (not shown) via the dust collecting duct 8. This dust collector serves to collect the worn shots T. When the dust collecting capacity of the dust collector (force to suck in the worn shots T) is low, that is, when there is an abnormality in the dust collecting capacity of the dust collector, then the worn shots T are not removed by the dust collector and are left in the shot peening apparatus 1 in a state of having smaller particle size. It is, therefore, when the worn shots T are scooped up by the buckets 22, because the particle size of the worn shots T have become smaller, the density of the shots T in the buckets 22 becomes higher compared to that of the shots T having large particle size as a natural result. As the density of the shots T in the buckets 22 becomes higher, the volume of the shots T scooped up by the buckets 22 becomes larger compared to when the density of the shots T in the buckets 22 are low. Therefore, the weight of the buckets 22 becomes heavier, thereby increasing the load on the motor M for the upper pulley 20A, and consequently, the current value of the motor M will increase.

Accordingly, when the control device 3 is configured to control the current value of the motor M and to issue an alert to the outside when the current value exceeds a certain current value (e.g., 3A), it becomes possible that the control device 3 informs the outside that an abnormality has occurred in the dust collection capacity of the dust collector (not shown) at an early stage.

Furthermore, by the configuration of the control device 3, in which it controls the current value of the motor M and issues an alert to the outside when the current value exceeds a certain current value, it becomes possible to inform the outside at an early stage of the fact that the shots T have been excessively put in the shot peening apparatus 1. That is, if the current value is determined in advance when the total amount of the shots T in the buckets 22 is made to flow, for example at about 80%, it can be seen that too much shots T have been put in the shot peening apparatus 1 when the current value exceeds the predetermined current value. Accordingly, the configuration of the control device 3 enables to inform the outside at an early stage of the fact that the shots T have been excessively put in the shot peening apparatus 1.

Furthermore, by the configuration of the control device 3, in which it controls the current value of the motor M and issues an alert to the outside when the current value exceeds a certain current value, it becomes possible to inform the outside at an early stage of the fact that the shots T having different volumetric density (shots T of different sizes) have been mixed. That is, in a case where the shots T having different volumetric density (shots T of different sizes) have been mixed, the total amount of the shots T in the buckets 22 becomes heavier than assumed, and thus the current value exceeds the assumed current value. Accordingly, the configuration of the control device 3 enables to inform the outside at an early stage of the fact that the shots T of different volumetric density (shots T of different sizes) have been mixed.

Whereas, by the configuration of the control device 3, in which it controls the current value of the motor M and issues an alert to the outside when the current value falls below a certain current value, it becomes possible to inform the outside at an early stage of the fact that the shots T having large particle size have been mixed. That is, in spite of using the shots T of the same material, if the shots T having large particle size have been erroneously mixed, the total amount of the shots T in the buckets 22 becomes lighter than assumed, and thus the current value falls below the assumed current value. Accordingly, the configuration of the control device 3 enables to inform the outside at an early stage of the fact that the shots T having large particle size have been mixed.

Furthermore, by the configuration of the control device 3, in which it controls the current value of the motor M and issues an alert to the outside when the current value exceeds a certain current value, it becomes possible to inform the outside at an early stage of the fact that the shots T having small particle size have been mixed. That is, in spite of using the shots T of the same material, if the shots T having small particle size have erroneously mixed, the total amount of the shots T in the buckets 22 becomes heavier than assumed, and thus the current value exceeds the assumed current value. Accordingly, the configuration of the control device 3 enables the control device 3 to inform the outside at an early stage of the fact that the shots T having small particle size have been mixed.

What is claimed is:

1. A shot peening apparatus for projecting shots onto a workpiece, comprising:
an elevating conveyance means for conveying shots to a predetermined height;
a motor for driving the elevating conveyance means;
a control means for controlling a current value of the motor; and
a projection means for projecting shots onto the workpiece.

2. The shot peening apparatus according to claim 1, wherein the control means is operable to issue an alert when a current value of the motor falls below a predetermined current value.

3. The shot peening apparatus according to claim 1, wherein the control means is operable to issue an alert when a current value of the motor exceeds a predetermined current value.
